(19) United States
(12) Patent Application Publication
(10) Pub. No.: US 2003/0233651 A1
(43) Pub. Date: Dec. 18, 2003

(54) System and method for parental control of digital display media

(76) Inventors: Elisha Rawle Edwin Farley, Greenville, SC (US); Obadiah Ferguson C. Farley, Greenville, SC (US); Felipe Jose Farley, Mauldin, SC (US)

Correspondence Address: Felipe J. Farley, P.O. Box 716, Mauldin, SC, 29662, US

(21) Appl. No.: 10/173,476

(22) Filed: Jun. 18, 2002

(51) Int. Cl. H04N 5/445; H04N 7/16

(52) U.S. Cl. 725/37; 725/41; 725/54; 725/139

(57) ABSTRACT

The present invention is a digital message rated by a propriety scheme having two or more propriety levels. The digital message can be played on a playback device in accordance with two or more propriety levels by association of a code with the playback device. The digital message might be selected from moving pictures, still pictures, music, music videos, games, audible stories, written stories, and news. The invention also includes the medium on which such a message is stored, including a computer-readable medium. The propriety schemes include, but are not limited to those schemes from the Motion Picture Industry Association (U.S.), the Recording Industry Association of America, and the Entertainment Software Rating Board

The present invention includes a system and method for playing a digital message according to a propriety scheme having two or more propriety levels. The system includes a digital message playable according to two or more levels of the propriety scheme; a playback device to play the digital message; and a means in the playback device to play one or more of the propriety levels of the digital message. In one embodiment the means is selected from a means for inputting a code to play a certain propriety level; a hard-wired dedicated means that plays only a fixed propriety level; a software-enabled means that plays only a certain propriety level; and a key-operated input means permitting the playing of a certain propriety level. In one embodiment of the invention, the playback device could be set to play a different propriety level of the message at a different time

The present invention is in the field of communication.

### BACKGROUND OF THE INVENTION

Parents are increasingly worried about what their children are seeing and hearing. All manner of electronic media now compete for the corruption, or ennoblement, of youngsters, including cable television, the internet, digital video disk players, compact disc players, and electronic games. However, as yet, there are only cumbersome and unworkable filters for inappropriate messages, such as those with a sexually suggestive or grotesquely violent character.

Therefore there is a need for an effective way of screening inappropriate messages from the tender eyes and ears of children.

### SUMMARY OF THE INVENTION

The present invention is a digital message rated by a propriety scheme having two or more propriety levels. The digital message can be played on a playback device in accordance with two or more propriety levels by association of a code with the playback device. The digital message might be selected from moving pictures, still pictures, music, music videos, games, audible stories, written stories, and news. The invention also includes the medium on which such a message is stored, including a computer-readable medium. The propriety schemes include, but are not limited to those schemes from the Motion Picture Industry Association (U.S.), the Recording Industry Association of America, and the Entertainment Software Rating Board

The present invention includes a system and method for playing a digital message according to a propriety scheme having two or more propriety levels. The system includes a digital message playable according to two or more levels of the propriety scheme; a playback device to play the digital message; and a means in the playback device to play one or more of the propriety levels of the digital message. In one embodiment the means is selected from a means for inputting a code to play a certain propriety level; a hard-wired dedicated means that plays only a fixed propriety level; a software-enabled means that plays only a certain propriety level; and a key-operated input means permitting the playing of a certain propriety level. In one embodiment of the invention, the playback device could be set to play a different propriety level of the message at a different time.

Therefore it is an object of the present invention to provide a system whereby parents can control the propriety of information presented to their children.

Therefore it is an object of the present invention to provide a system whereby a digital message can have different propriety levels.

These and other objects of the invention will become apparent upon an examination of the present specification, drawings, and appended claims.

### BRIEF DESCRIPTION OF THE DRAWINGS

FIG. 1 is a schematized version of the digital message of the present invention.

FIG. 2 is a flowchart showing how a user plays a digital message according to the present invention.

FIG. 3 is a flowchart showing how a user plays a digital message according to the present invention.

FIG. 4 is a flowchart showing how a user plays a digital message of a certain propriety level at a certain time according to the present invention.

FIG. 5 is an illustration of how a certain scene in a movie of a certain propriety level might be chosen to be played according to the present invention.

FIG. 6 is an illustration of the present invention using an electronic game as an example.

FIG. 7 is an illustration of the present invention using an electronic novel as an example.

FIG. 8 is an illustration of the present invention for streaming audio or video.

### DETAILED DESCRIPTION OF THE INVENTION

The present invention is a digital message rated by a propriety scheme having two or more propriety levels. The digital message can be played on a playback device in accordance with two or more propriety levels by association of a code with the playback device. The digital message might be selected from moving pictures, still pictures, music, music videos, games, audible stories, written stories, and news. The invention also includes the medium on which such a message is stored, including a computer-readable medium. The propriety schemes include, but are not limited to those schemes from the Motion Picture Industry Association (U.S.), the Recording Industry Association of America, and the Entertainment Software Rating Board

The present invention includes a system and method for playing a digital message according to a propriety scheme having two or more propriety levels. The system includes a digital message playable according to two or more levels of the propriety scheme; a playback device to play the digital message; and a means in the playback device to play one or more of the propriety levels of the digital message. In one embodiment the means is selected from a means for inputting a code to play a certain propriety level; a hard-wired dedicated means that plays only a fixed propriety level; a software-enabled means that plays only a certain propriety level; and a key-operated input means permitting the playing of a certain propriety level. In one embodiment of the invention, the playback device could be set to play a different propriety level of the message at a different time.

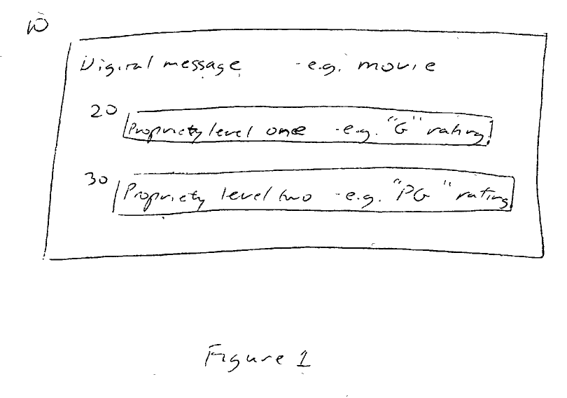

FIG. 1 illustrates the digital message of the present invention. It might be a movie, such as “Ugly Dinosaurs Attack!” The digital message might be transmitted from a web site, as an e-mail attachment, via a cable television transmission, or be stored on a physical medium such as a compact disk, digital video disk, memory card, or memory stick (colloquial term for additional memory storage means). The digital message would be rated according to two or more propriety schemes, such as the schemes from the Motion Picture Industry Association (U.S.), the Recording Industry Association of America, and the Entertainment Software Rating Board. The MPIA scheme includes the ratings General Audience (G), Parental Guidance suggested (PG), Parental Guidance suggested for those 13 or younger (PG-13), R-rated, and NC-17 for no one admitted under the age of seventeen, replacing the hoary “X” rating. The RIAA scheme includes parental advisory stickers for music describing sexual acts or extreme violence. The ESRB rates interactive software, including on-line games and those stored in a physical medium. Its ratings include Early Childhood (EC), Kids to Adult (K-A), Everyone (E), Teen (T), Mature (M), Adults Only (AO), Rating Pending (RP), and unrated.

According to FIG. 1, the digital message could be two entire versions of a movie, story, game, or picture. For example, track (20) might be propriety level one, a “G” rating. Track (30) might be at propriety level two, a “PG” rating. Each one would be accessible by means of association of a code with the digital message, most often by means of the user of a playback device inputting a code.

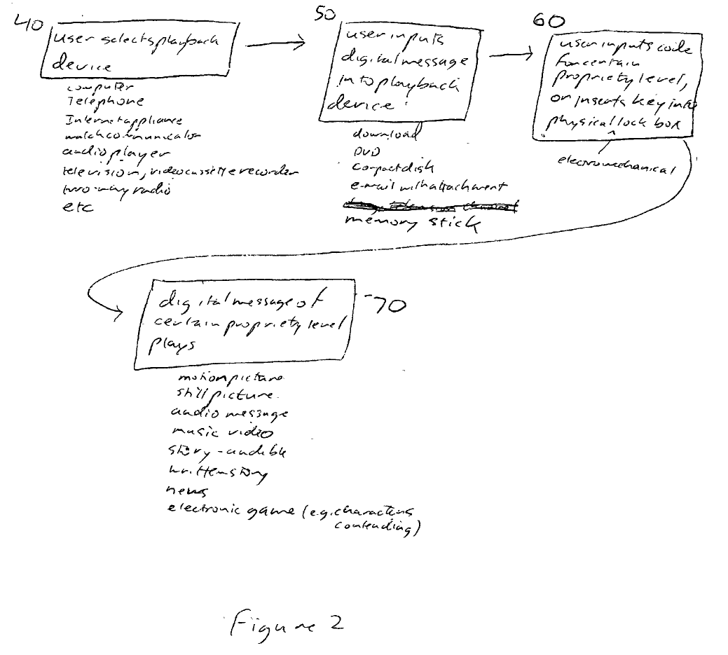

FIG. 2 illustrates how a user might employ the present invention. The user would select (40) a playback device, such as a computer, a telephone, an internet appliance, a watch communicator, an audio player, a television, a digital video disc player, a two-way radio, a pager, a personal digital assistant, etc. The user then inputs (50) the digital message into the playback device, or selects it if it is already stored therein. He might download the message, input a compact disc or digital video disc, receive an electronic mail transmission with an attachment. The user then associates (60) a code with the digital message for a certain propriety level. In one embodiment of the invention, he would input a code into the playback device via a user interface. In another embodiment he might turn a key in an electromechanical lock box, which would allow him to access the different propriety levels via a user interface on the playback device. Note that in the latter case, “association of a code with the digital message” might be inputting of the key, in this case a physical type of code. The digital message then plays (70) in the playback device.

In one embodiment of the invention, the means for inputting a code includes mechanical means for inputting a code, such as a lock, and electronic means, such as speech to text recognition means for voice input of a code. Software-enabled means includes means such as voice recognition means, fingerprint recognition means, face recognition means, and retinal scan means. This embodiment contemplates the recognition device, e.g. a fingerprint recognizing apparatus, generating the authorization code for the playback device. In otherwords, a user (e.g., a parent), presents his thumb to a fingerprint scanner, and the thumbprint is recognized. That parent than then input the propriety level the playback device will play through a user interface communicating with the playback device.

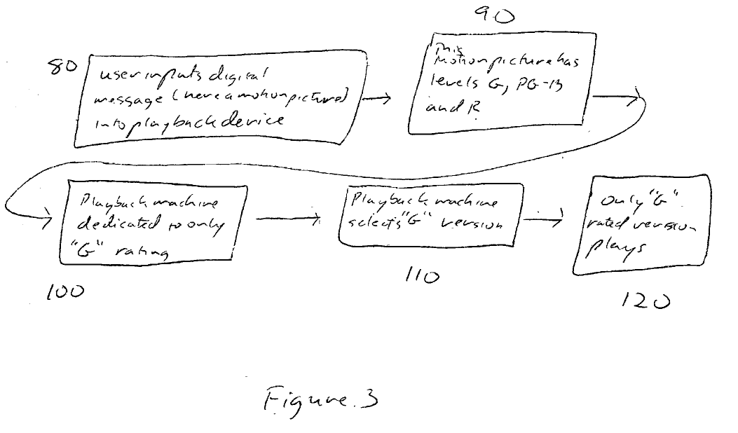

FIG. 3 illustrates one embodiment of the present invention where the playback device is dedicated to only one propriety level. A user, for example a child in his bedroom, inputs (80) the digital message into the playback device. For example, the digital message might be a motion picture 90), with levels G, PG-13, and R. The playback machine (100) might be dedicated to playing only the G-rated level. For example, a parent might place only a G-rated machine in a child's bedroom. The playback machine selects (110) the G version. Only the G-rated version plays (120). In one embodiment of the invention, the G-rated version might well be a cartoon version.

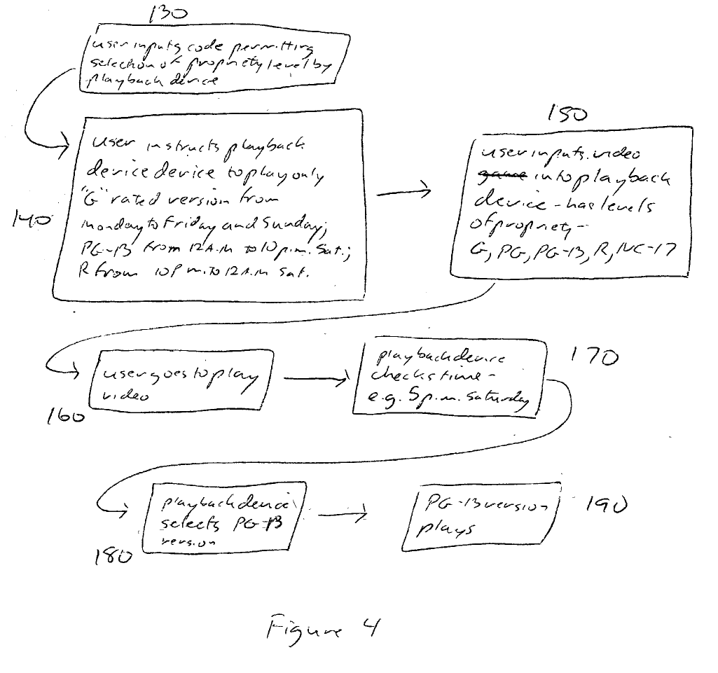

FIG. 4 illustrates one embodiment of the present invention where a user can cause a certain propriety level of a digital message to be played at a certain time of the day or calendar date. First the user inputs (130) a code permitting selection of a propriety level by the playback device. The user instructs (140) the playback device to play only the G-rated version of a movie from Monday to Friday and Sunday, the PG-13 rated version to play form 12 A.M. to 10 P.M. Saturday, and the R-rated verso to play from 10 P.M. to midnight on Saturday. The user inputs (150) a video into the playback device, which has propriety levels G, PG, PG-13, R, and NC-17. The user initiates (160) the play sequence for the movie. The playback device checks (170) the time, e.g. 5 p.m. Saturday. The playback device selects (180) the PG-13 version, and plays (190) the PG-13 rated version.

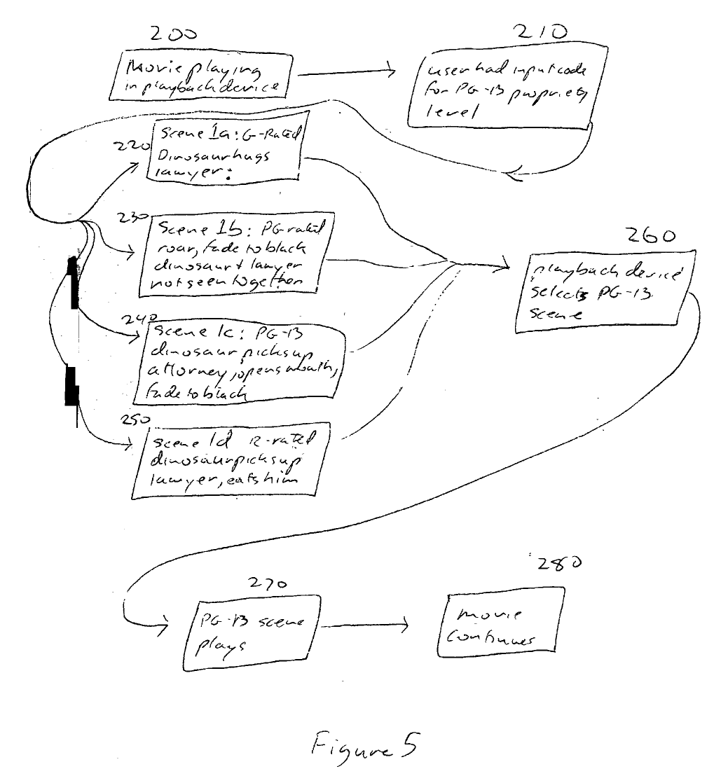

FIG. 5 illustrates one embodiment of the invention, where there is one main track for the digital message, and several alternate tracks at various points of the digital message, with each track having a different propriety rating. A movie is playing (200) in the playback device, e.g. “Ugly Dinosaurs Attack!” A user, probably a parent, had input (210) the code for the PG-13 propriety level. The movie goes along, and comes to a certain scene, call it scene 1, fifteen minutes into the movie. In scene 1a (220), the G-rated scene, a dinosaur hugs and attorney, and licks his face in a humorous manner with a big, slimy tongue. Scene 1b (230) is the PG-rated option. In this scene, there is a roar, and the scene fades to black, with the lawyer and dinosaur not seen together. In scene 1c, rated PG-13, the dinosaur picks up the attorney, opens his mouth revealing rather large, pointy teeth, and the scene fades to black. In scene 1d, the R-rated scene, the dinosaur picks up the lawyer and eats him. The playback device selects scene 1c, the PG-13 rated scene. Scene 1c, the PG-13 rated scene plays (270). The movie continues (280) smoothly. Preferably the scene changes are effected seamlessly, and are not even apparent to the viewer.

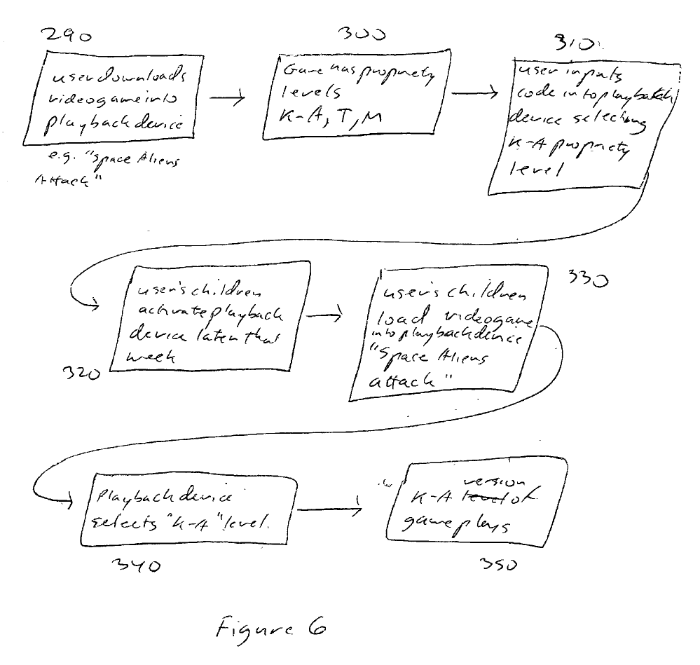

FIG. 6 illustrates the present invention with a digital message which is a video game, e.g. “Space Aliens Attack!” Certainly defending the earth is a noble enterprise, if a parent can make sure that his children do not employ overly violent methods to do so. Here the user downloads (290) the video game into the playback device. (He might also insert a cartridge or a disk). In this instance the game (300) has propriety levels K-A, T and M. The user inputs (310) the code into the playback device, selecting the K-A propriety level. Later that week, the user's children activate (320) the playback device. They load the videogame “Space Aliens Attack!” The playback device selects the K-A level. The K-A version of the game plays, with only moderate violence, and no gore.

In an alternative embodiment, the user might have set the playback device to only play the K-A level of any game loaded into the device.

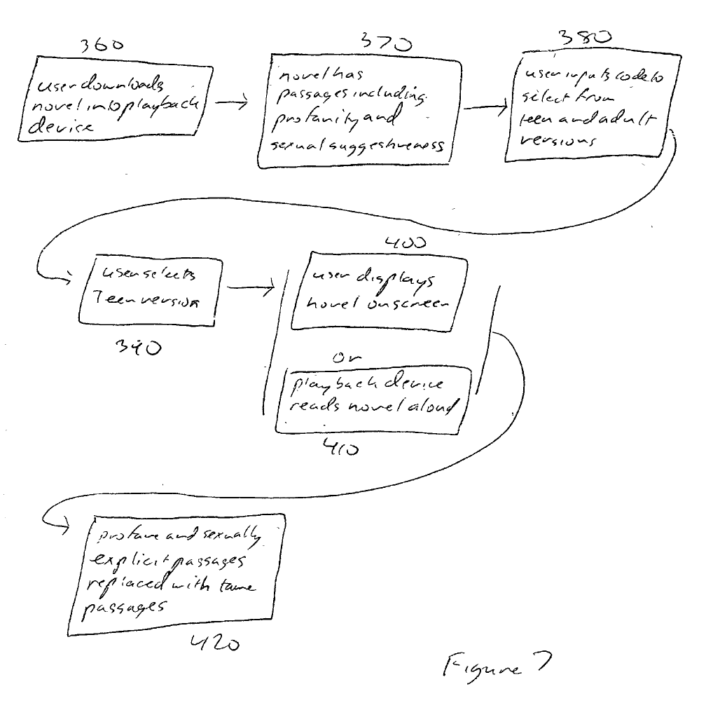

FIG. 7 illustrates another embodiment of the invention. Here a user downloads (360) a novel into the playback device, e.g. “Romance under a Misty Moon”. The novel has passages including (370) profanity and sexual suggestiveness. The user inputs (380) the code to select from teen and adult versions. The code input (390) is for the teen version. The user displays (400) the novel on screen, or the playback device might read the novel aloud (410). Since the teenager-appropriate level was selected, profane and sexually explicit passages were replaced with tame passages.

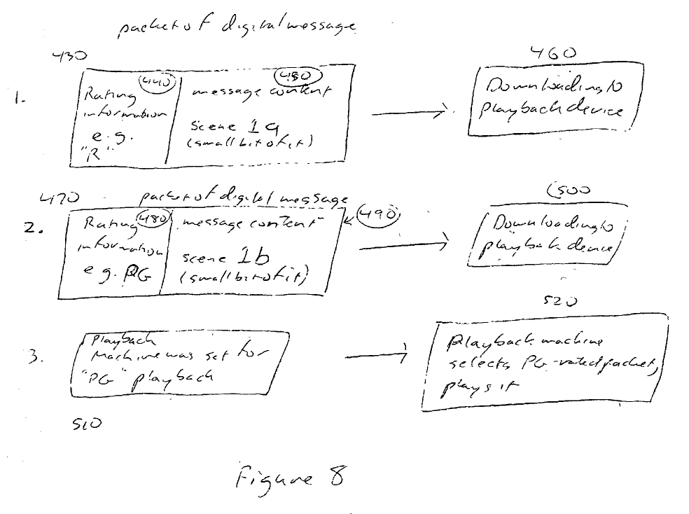

FIG. 8 illustrates the present invention for streaming audio or video. Each downloadable packet of information contains a ratings code. For example, in the case of a movie, packet (430) contains information designating it as as part of the “R” rated version. The message content (450) is a small part of scene variant 1a, the R-rated scene. The user downloads (460) the message to his playback device.

In Arabic number 2, the packet (470) of the digital message contains rating information (480) marking it as a PG-rated packet. The message content (490) is a small portion of the PG-rated scene. That is also downloaded to the playback device.

Arabic number 3 shows that the playback machine (510) was set for PG-rated playback only. Therefore the PG-rated packet is selected and played.

In the same manner each downloadable packet of a piece of music, such as a rap song, could be coded to indicate it had the “Parental Advisory” rating, or did not, and the playback device could be set to play either level.

In one embodiment of the invention, the playback device would be programmed by a parent, then given to a child, with the propriety level already set by the parent. For example, a personal computer might be set for motion pictures, music, and videogames, at the levels PG-13, no parental advisory warnings, and T, respectfully. The personal computer (playback device), would search for a code indicating the digital message were subject to a rating scheme, then select the appropriate rating level, and play that. In one embodiment of the invention, if the playback device encountered an unrated digital message, it would not play it. Makers of the digital message, would thereby be encouraged to include a standardized digital rating indicia in all their digital messages.

The playback device might be one that presents visual, auditory, olfactory, pressure, vibratory, magnetic, temperature, chemical, electrical, or immunological stimuli to a user. Also contemplated re playback machines connected directly to the nervous systems of the human body.

The present invention also includes a warranty system for a digital message stored on a first physical medium wherein a purchaser for a first price of said digital message stored on the physical medium is entitled to a replacement of the digital message stored on a second physical medium at a second price lower than said first price if the first physical medium is damaged after the the purchase. That lower second price could well be nothing at all. This warranty system recognizes that the information contained on a physical storage medium, and not the storage medium itself, is what has the real value.

Modifications and variations of the present invention will be apparent to those of skill in the art after an examination of the foregoing specification and appended claims. These are meant to fall within the scope of the appended claims.

We claim:

1. A digital message rated by a propriety scheme having two or more propriety levels wherein the digital message can be played on a playback device in accordance with two or more propriety levels by association of a code with the playback device.

2. The digital message of claim 1, wherein the message is selected from the group consisting of moving pictures, still pictures, music, music videos, games, audible stories, written stories, and news.

3. A computer-readable medium comprising the digital message of claim 1.

4. The digital message of claim 1, wherein the propriety scheme is a ratings scheme wherein the rating scheme is for a medium selected from the group consisting of motion pictures, videos, music videos, electronic games, recorded music, and television.

5. The digital message of claim 1, wherein the propriety scheme is selected from the group consisting of schemes from the Motion Picture Industry Association (U.S.), the Recording Industry Association of America, and the Entertainment Software Rating Board.

6. A system for playing a digital message according to a propriety scheme having two or more propriety level comprising:
(a) a digital message playable according to two or more levels of the propriety scheme:
(b) a playback device to play the digital message;
(c) a means in the playback device to play one or more of the propriety levels of the digital message.

7. The system of claim 7, wherein the means is selected from the group consisting of: (a) means for inputting a code to play a certain propriety level; (b) hard-wired dedicated means that plays only a fixed propriety level; (c) a software-enabled means that plays only a certain propriety level; (d) a key-operated input means permitting the playing of a certain propriety level.

8. The system of claim 7, wherein the means for inputting a code includes mechanical means for inputting a code, such as a lock, and electronic means, such as speech to text recognition means for voice input of a code, and the software-enabled means includes means selected from the group consisting of voice recognition means, fingerprint recognition means, face recognition means, and retinal scan means.

9. The system of claim 1 wherein the playback device is selected from the group consisting of televisions, computers, personal digital assistants, digital video disk players, radios, audio players, internet appliances, pagers, watch communicators, and telephones.

10. The system of claim 1 wherein the playback device is selected from the group of playback devices that interact with a user according to the senses of taste, touch, smell, temperature, hearing.

11. The system of claim 1 wherein the playback device is selected from the group of playback devices that interact with the user according to magnetism, electricity or quantum effects.

12. The system of claim 1, further comprising wherein the playback device can be set to play a different propriety level at a different time.

13. The system of claim 1, wherein the different time is selected from the group consisting of time of the day, and calendar time.

14. The digital message of claim 1, further comprising the system wherein the digital message is transmitted to the playback device by means of a television signal, satellite signal, cable television signal, telephone line transmission, and wireless telephone transmission.

15. The digital message of claim 14, wherein the message transmission is selected from the group of means consisting of downloading from a web site and electronic mail transmission.

16. The digital message of claim 1, wherein the digital message is selected from the group consisting of still pictures and moving pictures, and wherein at least one of the propriety levels is a cartoon.

17. The digital message of claim 5, wherein if the propriety scheme is the rating scheme of the Motion Picture Association, the rating levels are selected from the group consisting of G, PG, PG-13, R, NC-17, unrated, and not yet rated, and wherein if the propriety scheme is the rating scheme of the Recording Industry Association of America the rating levels are selected from the group consisting of Parental Advisory warning, no parental advisory warning, and unrated, and wherein if the propriety scheme is the rating scheme of the Entertainment Software Rating Board, the rating levels are selected from the group consisting of Early Childhood (EC), Kids to Adult (K-A), Everyone (E), Teen (T), Mature (M), Adults Only (AO), Rating Pending (RP), and unrated.

18. A warranty system for a digital message stored on a first physical medium wherein a purchaser for a first price of said digital message stored on the physical medium is entitled to a replacement of the digital message stored on a second physical medium at a second price lower than said first price if the first physical medium is damaged after the the purchase.

19. The warranty system of claim 18 wherein the digital message is selected from the group consisting of motion pictures, still pictures, stories, music, music videos, and electronic games, and the second price is zero dollars, and further comprising where the provider of the digital message causes the second physical medium with the stored digital message to be transmitted to the purchaser.

20. A computer-implemented system for playing a digital message according to a propriety scheme having two or more propriety level comprising:
(a) a digital message playable according to two or more levels of the propriety scheme:
(b) a playback device to play the digital message;
(c) a means in the playback device to play one or more of the propriety levels of the digital message.
